(19) United States
(12) Patent Application Publication
(10) Pub. No.: US 2026/0022721 A1
(43) Pub. Date: Jan. 22, 2026

(54) ARRANGEMENT FOR SECURING AGAINST DISENGAGEMENT

(71) Applicant: Mytronic GmbH, Weilrod (DE)

(72) Inventor: Wolfgang Schreiber, Schöffengrund (DE)

(73) Assignee: Mytronic GmbH, Weilrod (DE)

(21) Appl. No.: 19/273,037

(22) Filed: Jul. 17, 2025

(30) Foreign Application Priority Data
Jul. 18, 2024 (DE) 102024120322.6

(51) Int. Cl. F16B 2/22; F16B 41/00

(52) U.S. Cl. CPC F16B 2/22; F16B 41/002

(57) ABSTRACT

A securing arrangement is proposed herein. The securing arrangement has an at least approximately cylindrical element and a counter element.

### CROSS-REFERENCE TO RELATED APPLICATIONS

This application claims priority under 35 U.S.C 119 to German Patent Application No. 102024120322.6, filed Jul. 18, 2024; this disclosure of which is incorporated herein by reference in its entirety.

The present invention relates to a securing arrangement.

Securing elements are used to protect machine parts. Securing elements are small, often barely visible machine components, which are used in almost every machine construction. The form-fitting components protect and, as guide elements, limit other machine parts against axial play. Securing elements are available in many designs. They are thus suitable for different applications. Securing elements known from the prior art are, for example, circlips, spring cotter pins and Fokker pins (also referred to as securing clips).

It is common to the prior art that corresponding securing measures generally provide or require an additional element.

There is a need for an improved securing arrangement. In particular, there is a need for a securing arrangement which manages with as few additional elements as possible, ideally with no additional elements, and/or which is constructed as simply as possible.

According to a first aspect, a securing arrangement is proposed. The securing arrangement has an at least approximately cylindrical element. The at least approximately cylindrical element has a winding that is wound in a winding direction around a longitudinal axis of the at least approximately cylindrical element. The winding has a winding pitch. The securing arrangement has a counter element. The counter element has an at least approximately cylindrical portion. The counter element has a threaded portion arranged on the at least approximately cylindrical portion. The threaded portion has a thread direction and a thread pitch. The thread direction and the thread pitch of the threaded portion are matched to the winding direction and the winding pitch of the at least approximately cylindrical element. The thread direction and the thread pitch of the threaded portion are matched to the winding direction and the winding pitch of the at least approximately cylindrical element in such a manner that the at least approximately cylindrical element can be applied to, in particular screwed or twisted or pushed onto, the counter element in a direction of rotation. In addition or alternatively, the thread direction and the thread pitch of the threaded portion are matched to the winding direction and the winding pitch of the at least approximately cylindrical element in such a manner that the counter element can be applied to, in particular screwed or twisted or pushed onto, the at least approximately cylindrical element in a direction of rotation. In a connected state of the at least approximately cylindrical element and the counter element brought about by the application, in particular the screwing or twisting or pushing on, the at least approximately cylindrical element cooperates with the counter element. In a connected state of the at least approximately cylindrical element and the counter element brought about by the application, in particular the screwing or twisting or pushing on, the at least approximately cylindrical element cooperates with the counter element in such a manner that, if the at least approximately cylindrical element and/or the counter element are/is rotated in the opposite direction to the direction of rotation, a frictional force is generated between the at least approximately cylindrical element and the counter element such that the frictional force prevents the at least approximately cylindrical element and the counter element from being disengaged from one another.

In other words, in the connected state of the at least approximately cylindrical element and the counter element, the at least approximately cylindrical element cooperates with the counter element. The cooperation has the result that, if the at least approximately cylindrical element and/or the counter element are/is rotated in the opposite direction to the direction of rotation, a frictional force is generated between the at least approximately cylindrical element and the counter element. The frictional force that is generated prevents the at least approximately cylindrical element and the counter element from being disengaged from one another.

Apart from the at least approximately cylindrical element and the counter element, the securing arrangement does not require any additional, separate elements.

In conventional rotational connections of two elements that have been established by rotation in a direction of rotation, the rotational connections can be disengaged if at least one of the elements is rotated in the corresponding opposite direction of rotation sufficiently firmly/greatly that a certain frictional force is overcome. By contrast, the rotational connection between the at least approximately cylindrical element and the counter element cannot be disengaged by application of a comparably great torque in the opposite direction to the direction of rotation or by application of usual torques in the opposite direction to the direction of rotation. The at least approximately cylindrical element and the counter element remain connected, so that a securing mechanism is provided.

Herein, application can generally include screwing on or twisting on or pushing on. For example, pushing on can include pushing on with force.

Accordingly, application of the at least approximately cylindrical element to the counter element in a direction of rotation can include in particular screwing or twisting the at least approximately cylindrical element onto the counter element in a direction of rotation. In addition or alternatively, application of the counter element to the at least approximately cylindrical element in a direction of rotation can include screwing or twisting the counter element onto the at least approximately cylindrical element in a direction of rotation.

Application of the at least approximately cylindrical element to the counter element in a direction of rotation can further include in particular pushing on, in particular pushing on with force, in such a manner as to achieve a movement that is also achieved when the at least approximately cylindrical element is screwed or twisted onto the counter element in a direction of rotation. In addition or alternatively, application of the counter element to the at least approximately cylindrical element in a direction of rotation can include pushing on, in particular pushing on with force, in such a manner as to achieve a movement that is also achieved when the counter element is screwed or twisted onto the at least approximately cylindrical element in a direction of rotation.

The at least approximately cylindrical element can have a spring-like element or can be in the form of a spring-like element. For example, the at least approximately cylindrical element can have a spring element or can be in the form of a spring element. The at least approximately cylindrical element can have a nut-shaped element with an internal thread or can be in the form of a nut-shaped element. In particular, the at least approximately cylindrical element can have a certain flexibility at least in some portions or can be configured so that it is not completely rigid at least in some portions.

The at least approximately cylindrical element can have a plane surface in at least one end region. The plane surface can be ground. The plane surface can thus have a ground plane surface or can be in the form of a ground plane surface. The counter element can have a counter plane surface. The counter plane surface can be ground. The counter plane surface can thus have a ground counter plane surface or can be in the form of a ground counter plane surface. For example, the plane surface can be arranged on at least one end face of the at least approximately cylindrical element. The plane surface can run at least approximately perpendicular to the longitudinal direction of the at least approximately cylindrical element. The counter plane surface can run at least approximately perpendicular to the longitudinal direction of the at least approximately cylindrical element and/or of the counter element.

In the connected state of the at least approximately cylindrical element and the counter element brought about by the application, in particular the screwing or twisting or pushing on, the plane surface and the counter plane surface can cooperate in such a manner that at least part of the frictional force is generated. In other words, in the connected state of the at least approximately cylindrical element and the counter element brought about by the application, in particular the screwing or twisting or pushing on, the plane surface and the counter plane surface can cooperate. At least part of the frictional force can be generated by the cooperation. For example, in the connected state of the at least approximately cylindrical element and the counter element brought about by the application, in particular the screwing or twisting or pushing on, the plane surface and the counter plane surface can come into contact with one another at least in some portions or can abut one another at least in some portions. At least part of the frictional force can thus be generated on rotation in the opposite direction to the direction of rotation.

In the connected state of the at least approximately cylindrical element and the counter element brought about by the application, in particular the screwing or twisting or pushing on, the at least approximately cylindrical element can cooperate with the counter element in such a manner that, on rotation in the opposite direction to the direction of rotation, a first torsion of the at least approximately cylindrical element effects a tapering of the cross section of the at least approximately cylindrical element in a region of the at least approximately cylindrical portion in such a manner that the tapering of the cross section effects clamping between the at least approximately cylindrical element and the at least approximately cylindrical portion, said clamping generating at least part of the frictional force. In other words, in the connected state of the at least approximately cylindrical element and the counter element brought about by the application, in particular the screwing or twisting or pushing on, the at least approximately cylindrical element can cooperate with the counter element. As a result of the cooperation, on rotation in the opposite direction to the direction of rotation, a first torsion of the at least approximately cylindrical element can effect a tapering of the cross section of the at least approximately cylindrical element in a region of the at least approximately cylindrical portion. The tapering of the cross section can effect clamping between the at least approximately cylindrical element and the at least approximately cylindrical portion, said clamping generating at least part of the frictional force.

The at least approximately cylindrical portion can have a thread-free portion. The thread-free portion can adjoin the threaded portion. The thread-free portion can in particular adjoin the threaded portion directly. The counter plane surface can extend from the thread-free portion, for example, at least approximately perpendicular to the thread-free portion.

In a connected state of the at least approximately cylindrical element and the counter element brought about by the application, in particular the screwing or twisting or pushing on, the at least approximately cylindrical element can cooperate with the counter element in such a manner that, on rotation in the direction of rotation and a pulling movement, along the longitudinal axis, of the at least approximately cylindrical element and/or of the counter element, a second torsion of the at least approximately cylindrical element effects an increase in the cross section of the at least approximately cylindrical element in a region of the at least approximately cylindrical portion, said increase in the cross section permitting disengagement. In other words, in a connected state of the at least approximately cylindrical element and the counter element brought about by the application, in particular the screwing or twisting or pushing on, the at least approximately cylindrical element can cooperate with the counter element. As a result of the cooperation, on rotation in the direction of rotation and a pulling movement along the longitudinal axis of the at least approximately cylindrical element and/or of the counter element, a second torsion of the at least approximately cylindrical element can effect an increase in the cross section of the at least approximately cylindrical element in a region of the at least approximately cylindrical portion. The increase in the cross section can permit or effect disengagement of the at least approximately cylindrical element from the counter element. For example, as a result of the increase in the cross section, part of the frictional force that otherwise acts can be eliminated or reduced.

In conventional rotational connections of two elements that have been established by rotation in a direction of rotation, the rotational connections can be disengaged if at least one of the elements is rotated in the corresponding opposite direction of rotation sufficiently firmly and/or greatly that a certain frictional force is overcome. By contrast, the rotational connection between the at least approximately cylindrical element and the counter element cannot be disengaged by rotation in the opposite direction to the direction of rotation but via rotation in the direction of rotation in combination with a pulling movement. As a result, disengagement of the connection is possible. However, the pulling and rotating movement necessary therefor is unusual and has the result that the connection is not disengaged unintentionally but only when this is actually intended. This increases the security and reliability of the securing arrangement.

An inside diameter of the at least approximately cylindrical element can be matched to an outside diameter of the at least approximately cylindrical portion or vice versa. The inside diameter of the at least approximately cylindrical element can in particular correspond at least approximately to the outside diameter of the at least approximately cylindrical portion. In this way, the at least approximately cylindrical element can be applied to, in particular screwed or twisted or pushed onto, the counter element without the presence of further elements.

The counter element can have a cover. In a connected state of the at least approximately cylindrical element and the counter element brought about by the application, in particular the screwing or twisting or pushing on, the cover can enclose at least a region of the at least approximately cylindrical element.

According to a second aspect, a securing method is proposed. The securing method is carried out with a securing arrangement according to the first aspect. The securing method comprises applying, in particular screwing or twisting or pushing, the at least approximately cylindrical element onto the counter element in a direction of rotation. In addition or alternatively, the securing method comprises applying, in particular screwing or twisting or pushing, the counter element onto the at least approximately cylindrical element in a direction of rotation. In a connected state of the at least approximately cylindrical element and the counter element brought about by the application, in particular the screwing or twisting or pushing on, the at least approximately cylindrical element cooperates with the counter element. The securing method comprises rotating the at least approximately cylindrical element and/or the counter element in the opposite direction to the direction of rotation. As a result of the rotation in the opposite direction to the direction of rotation, a frictional force is generated between the at least approximately cylindrical element and the counter element. The frictional force prevents the at least approximately cylindrical element and the counter element from being disengaged from one another.

Although some of the aspects described above have been described in relation to the securing arrangement according to the first aspect, these aspects can also be or have been implemented in a corresponding manner in the securing method according to the second aspect.

The present disclosure will be explained further with reference to figures. These figures show, schematically:

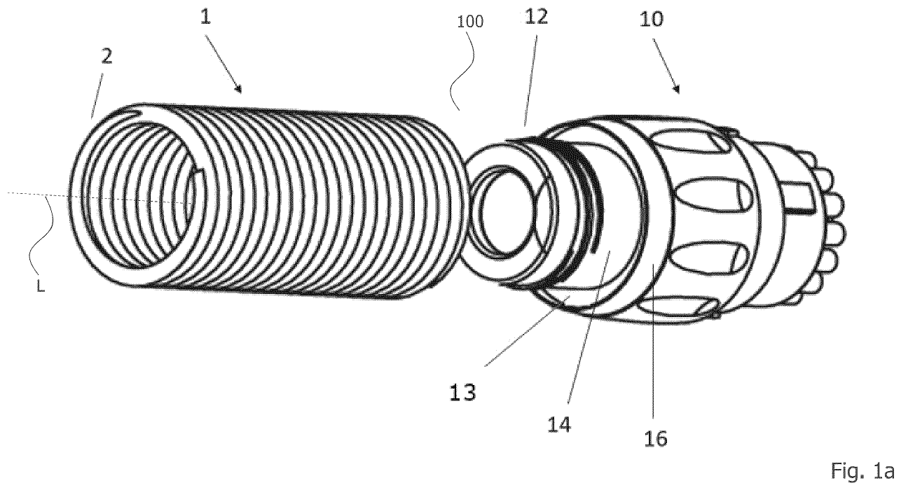

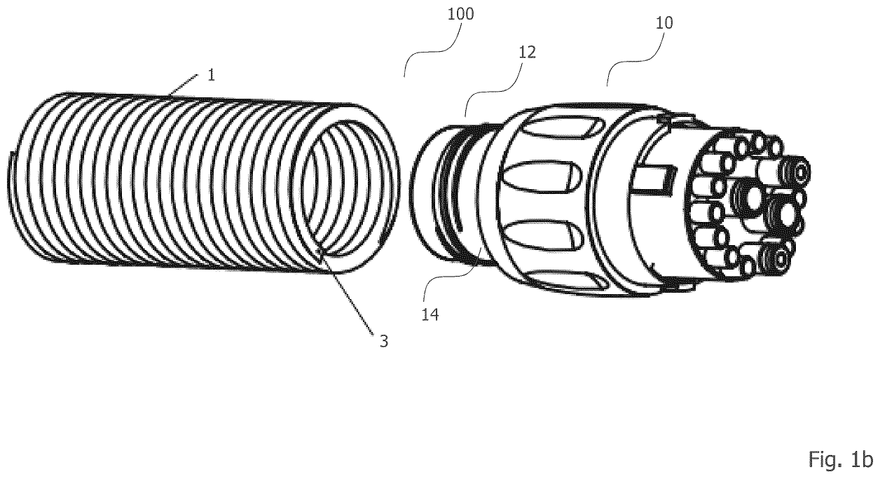

FIG. 1a a perspective view of a securing arrangement according to an exemplary embodiment in an unconnected state;

FIG. 1b a further perspective view of the securing arrangement according to the exemplary embodiment in an unconnected state;

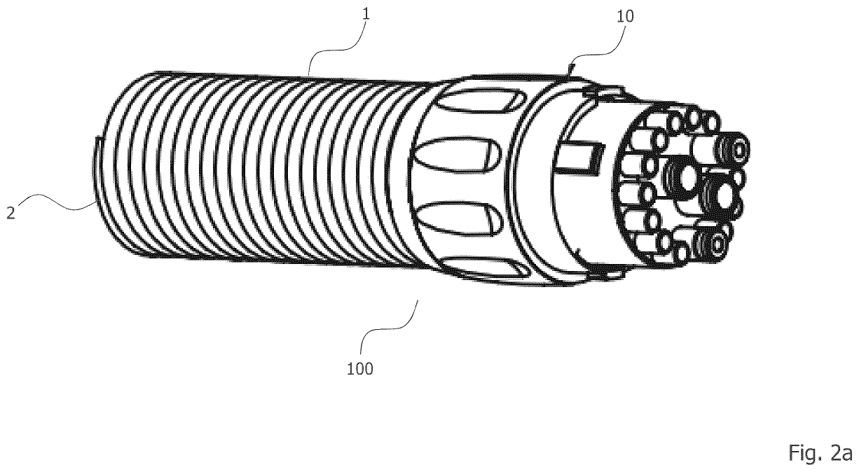

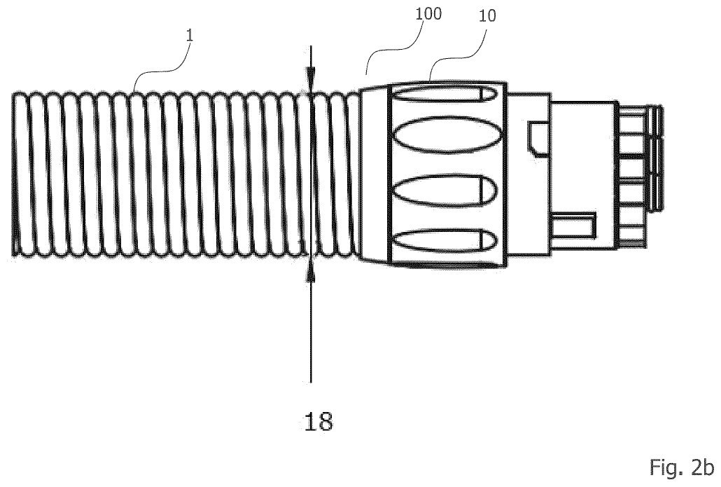

FIG. 2a a perspective view of the securing arrangement according to the exemplary embodiment in a connected state;

FIG. 2b a side view of the securing arrangement according to the exemplary embodiment in a connected state.

In the following, specific details are presented, without implying any limitation, in order to provide a complete understanding of the present disclosure. However, it will be clear to a person skilled in the art that the present disclosure can be used in other exemplary embodiments, which may differ from the details presented below. For example, in the following, specific configurations and embodiments of a securing arrangement are described, which are not to be regarded as limiting. Furthermore, in the following, application of a spring element to a counter element/application of the counter element to the spring element is always described by way of example as screwing on or twisting on, but other implementations, such as pushing on, for example pushing on with force, are possible.

FIG. 1a shows, schematically, a securing arrangement 100. The securing arrangement 100 has an at least approximately cylindrical element 1. In the exemplary embodiment shown in FIGS. 1a to 2b, the at least approximately cylindrical element 1 is, purely by way of example, in the form of a spring-like or spring element 1 and may therefore also be referred to in the following as a spring element 1 or also simply as a spring 1. The spring element 1 has a winding that is wound in a winding direction around a longitudinal axis L of the spring element 1. The winding has a winding pitch. The longitudinal axis L at the same time also denotes a longitudinal axis of the securing arrangement 100. The longitudinal axis L is an axis extending in the longitudinal direction of the spring element 1 or an axis of a greatest extent of the spring element and/or of the securing arrangement.

The securing arrangement 100 has a counter element 10. In the exemplary embodiment shown in FIGS. 1a to 2b, the counter element 10 is, by way of example, in the form of a plug part to which multiple lines are guided and may accordingly also be referred to as a plug part 10 or base plug part 10. In the exemplary embodiment shown, the longitudinal axis L of the spring element 1 corresponds to the longitudinal axis of the counter element 10. The counter element 10 has an at least approximately cylindrical portion. The at least approximately cylindrical portion has a threaded portion 12. The threaded portion 12 has a thread direction and a thread pitch. The thread direction and the thread pitch of the threaded portion 12 are matched to the winding direction and the winding pitch of the spring element 1. As a result, it is possible to screw the spring element 1 onto the counter element 10 in a direction of rotation. Alternatively, it is possible to screw the counter element 10 onto the spring element in a direction of rotation. Furthermore, combined screwing on of the spring element 1 and the counter element 10 relative to one another is possible. In the exemplary embodiment of FIGS. 1a to 2d that is shown, represented by way of example as a right-hand thread, which allows the spring element 1 to be screwed or twisted onto the counter element by a right-hand rotation, i.e. a clockwise rotation.

An inside diameter of the spring element 1 is matched to an outside diameter of the at least approximately cylindrical portion of the counter element 10. More specifically, the inside diameter of the spring element 1 corresponds at least approximately to the outside diameter of the at least approximately cylindrical portion of the counter element 10. As a result, on the one hand screwing of the spring element 1 relative to the counter element 10 is possible. On the other hand, the spring element 1, after it has been screwed on, sits on the counter element 10 with an accurate fit, and form fitting in the radial direction (of the spring element 1) between the spring element 1 and the counter element 10 is obtained. The counter element 10 further optionally has a cover 16. The cover may also be omitted. The cover 16 has a larger diameter than the at least approximately cylindrical portion.

In an alternative embodiment, the spring element may also be composed of multiple spring elements (not shown), wherein, as a further embodiment, it is additionally possible for a further counter element in the form of a fixed portion (not shown) to be arranged between the multiple spring elements, which fixed portion may not be resilient, for example may consist of a metal or plastics material.

The spring element 1 has in an end region a plane surface 2, for example a ground plane surface, as can be seen in FIGS. 1a, 2a and 2b. More specifically, the spring element 1 has the plane surface 2 on a first end face. The spring element 1 has in another end region a plane surface 3, for example a ground plane surface, as can be seen in FIG. 1b. More specifically, the spring element 1 has the plane surface 3 on a second end face. The spring element 1 (the spring) thus has, by way of example, a ground plane surface 2, 3 at both ends. The counter element 10 has a counter plane surface 13, as can be seen in FIG. 1a. The counter plane surface 13 is set back relative to the cover 16. In this way, the counter plane surface 13 is enclosed by the cover 16.

The spring element can be screwed over the threaded portion 12 (=the portion of the at least approximately cylindrical portion that has a thread) of the counter element 10. In the screwed-on state, the spring element 1 ends at/on the counter plane surface 13 of the counter element 10; more specifically, the plane surface 3 of the spring element 1 ends at the counter plane surface 13.

The at least approximately cylindrical portion of the counter element 10 has a thread-free portion 14. In the exemplary embodiment shown, the thread-free portion 14, by way of example, adjoins the threaded portion 12 directly. The counter plane surface 13 extends from the thread-free portion 14 perpendicular to the threaded portion 12 and the longitudinal axis L. In the exemplary embodiment shown, the counter plane surface 13 directly adjoins an end of the thread-free portion 14 that is opposite the threaded portion 12.

A connected state of the spring element 1 and the counter element 10 brought about by screwing on is shown by way of example in FIGS. 2a and 2b. This state may also be referred to simply as the connected state for short.

In the connected state, the spring element 1 cooperates with the counter element 10. The cover 16, in the connected state, encloses at least a region of the spring element 1.

In the connected state, the spring element 1 and the counter element 10 cannot be disengaged from one another in the usual way by rotation in the opposite direction to the direction of rotation, i.e. in the example shown by rotation of the spring element 1 anticlockwise. On rotation of the spring element 1 and/or of the counter element 10 in the opposite direction to the direction of rotation, a frictional force is generated between the spring element 1 and the counter element 10. The frictional force prevents the spring element 1 and the counter element 10 from being disengaged from one another. The frictional force is also referred to hereinbelow as the total frictional force.

The plane surface 3 and the counter plane surface 13 cooperate in the connected state. More specifically, frictional engagement occurs between the plane surface 3 and the counter plane surface 13 and acts in the opposite direction to the direction of rotation. Owing to the frictional engagement, when the spring element 1 and/or the counter element 10 are/is rotated in the opposite direction to the direction of rotation, a first frictional force, which forms at least part of the total frictional force, is generated.

Furthermore, frictional engagement occurs between the spring element 1 and the counter element 10 in a direction along the longitudinal axis L. More specifically, frictional engagement occurs as a result of contact between regions of the spring element 1 and of the cylindrical portion that are directly in contact with one another. The frictional engagement acts in a direction along the longitudinal axis L on rotation in the opposite direction to the direction of rotation. Owing to the frictional engagement, when the spring element 1 and/or the counter element 10 are/is rotated in the opposite direction to the direction of rotation, a second frictional force, which forms at least part of the total frictional force, is generated.

Owing to the thread engagement between the spring element 1 and the counter element 10, more specifically between the spring element 1 and the threaded portion 12, form-fitting engagement further acts in a direction along the longitudinal axis L.

In the connected state, a first torsion of the spring element 1 occurs on rotation in the opposite direction to the direction of rotation. This first torsion effects a tapering 18 of the cross section of the spring element 1 in a region of the at least approximately cylindrical portion of the counter element 10, as shown in FIG. 2b. The tapering 18 of the cross section effects clamping between the spring element 1 and the at least approximately cylindrical portion. The clamping generates, for example, a third frictional force, which forms at least part of the total frictional force. In particular, the total frictional force that acts is enhanced by the clamping.

The counter element 10 has, as described, a threaded portion 12 beginning at the end of the component, which threaded portion matches the pitch of the spring element 1 and ends in a thread-free portion 14 (which may also be referred to as the shaft region) with the dimension of the inside diameter of the spring element 1. The position of the threaded portion 12 and the number of thread turns have no influence on the securing function. Rather, the securing function is effected via interlocking of the spring element 1 with the plane surface 3 and the counter plane surface 13 via the threaded portion 12. If it is attempted to twist off the spring element 1, twisting off is prevented via a tapering 18 of the cross section of the spring element 1.

In summary, it can be said that the securing arrangement 100, for example a spring securing arrangement, is provided and reliably prevents the spring element 1 from simply being twisted off the counter element 10 (e.g. a plug part) or the counter element 10 simply being twisted off the spring element 1 or combined twisting off of the spring element 1 and the counter element 10 relative to one another.

Disengagement of the spring element 1 and the counter element 10 is made possible by an unusual combination of movements. On rotation in the direction of rotation (clockwise rotation in the present example) and a pulling movement along the longitudinal axis L, a second torsion of the spring element 1 is generated. The second torsion effects an increase in the cross section of the spring element 1 in a region of the at least approximately cylindrical portion of the counter element 10. The increase in cross section allows the spring element 1 and the counter element 10 to be disengaged from one another. In particular, a frictional force that is acting, in particular the above-mentioned total frictional force, is reduced by the increase in cross section. Consequently, securing can be eliminated again by a tensile-torsional force without the provision of further elements for securing.

The exposed thread-free portion 14 (shaft region) can additionally have been or be provided with the above-mentioned (spring) cover 16. However, this has no influence on the securing function. Once the spring element 1 (the spring) has been screwed on with a tightening torque of between 0.3 Nm and 0.4 Nm, for example, it can no longer be disengaged simply by rotation in the opposite direction to the direction of rotation (e.g. a left-hand rotation). This is because the friction forces/frictional forces of the plane surface 3 and of the counter plane surface 13 of the counter element 10 and the spring element 1 initially hold the spring element 1 in position, and a tapering 18 of the cross section then occurs in the region of the spring element 1 and the friction is thus increased. For disengaging the spring securing arrangement, the spring element 1 is rotated in the direction of rotation (e.g. to the right, i.e. clockwise) and pulled. This has the result that, as a result of the torsion in the previous region of the tapering 18 of the cross section, the spring element 1 increases in diameter and can thus be pushed over the threaded portion 12, and the interlocked spring element 1 can be disengaged.

In an alternative embodiment, the spring securing function can also be applied for a left-hand thread. The fundamental requirement here is to form the matching spring winding to the left. The same also applies to the counter element 10 (the base plug part).

1. A securing arrangement having:
an at least approximately cylindrical element having a winding wound in a winding direction around a longitudinal axis of the at least approximately cylindrical element and having a winding pitch;
a counter element having an at least approximately cylindrical portion and a threaded portion arranged on the at least approximately cylindrical portion, which threaded portion has a thread direction and a thread pitch, wherein the thread direction and the thread pitch of the threaded portion are matched to the winding direction and the winding pitch of the at least approximately cylindrical element in such a manner that it is possible to apply, in particular screw or twist or push, the at least approximately cylindrical element onto the counter element and/or to apply, in particular screw or twist or push, the counter element onto the at least approximately cylindrical element in a direction of rotation;
wherein, in a connected state of the at least approximately cylindrical element and the counter element brought about by the application, the at least approximately cylindrical element cooperates with the counter element in such a manner that, if the at least approximately cylindrical element and/or the counter element are/is rotated in the opposite direction to the direction of rotation, a frictional force is generated between the at least approximately cylindrical element and the counter element such that the frictional force prevents the at least approximately cylindrical element and the counter element from being disengaged from one another.

2. The securing arrangement as claimed in claim 1, wherein the at least approximately cylindrical element has a plane surface, in particular a ground plane surface, in at least one end region, and the counter element has a counter plane surface.

3. The securing arrangement as claimed in claim 2, wherein, in the connected state of the at least approximately cylindrical element and the counter element brought about by the application, in particular the screwing or twisting or pushing on, the plane surface and the counter plane surface cooperate with one another in such a manner that at least part of the frictional force is generated.

4. The securing arrangement as claimed in claim 1, wherein, in the connected state of the at least approximately cylindrical element and the counter element brought about by the application, in particular the screwing or twisting or pushing on, the at least approximately cylindrical element cooperates with the counter element in such a manner that, on rotation in the opposite direction to the direction of rotation, a first torsion of the at least approximately cylindrical element effects a tapering of the cross section of the at least approximately cylindrical element in a region of the at least approximately cylindrical portion such that the tapering of the cross section effects clamping between the at least approximately cylindrical element and the at least approximately cylindrical portion, said clamping generating at least part of the frictional force.

5. The securing arrangement as claimed in claim 1, wherein the at least approximately cylindrical portion has a thread-free portion, in particular adjoining the threaded portion.

6. The securing arrangement as claimed in claim 1, wherein, in a connected state of the at least approximately cylindrical element and the counter element brought about by the application, in particular the screwing or twisting or pushing on, the at least approximately cylindrical element cooperates with the counter element in such a manner that, on rotation in the direction of rotation and a pulling movement, along the longitudinal axis, of the at least approximately cylindrical element and/or of the counter element, a second torsion of the at least approximately cylindrical element effects an increase in the cross section of the at least approximately cylindrical element in a region of the at least approximately cylindrical portion, said increase in cross section permitting disengagement.

7. The securing arrangement as claimed in claim 1, wherein an inside diameter of the at least approximately cylindrical element is matched to an outside diameter of the at least approximately cylindrical portion, in particular corresponds at least approximately thereto.

8. The securing arrangement as claimed in claim 1, wherein the counter element further has a cover which, in a connected state of the at least approximately cylindrical element and the counter element brought about by the application, in particular the screwing or twisting or pushing on, encloses at least a region of the at least approximately cylindrical element.
